(19) United States
(12) Patent Application Publication
(10) Pub. No.: US 2026/0158632 A1
(43) Pub. Date: Jun. 11, 2026

(54) Geared Torque Tool and a Unitary Subassembly for the Same

(71) Applicant: NEW WORLD TECHNOLOGIES INC., Abbotsford (CA)

(72) Inventors: Christopher James MCKERIHEN, Abbotsford (CA); Luke Anthony TIMMERMANS, Abbotsford (CA)

(21) Appl. No.: 18/755,284

(22) PCT Filed: Mar. 23, 2023
(86) PCT No.: PCT/CA2023/050392

§ 371 Date: Jun. 26, 2024

(51) Int. Cl. B25F 5/00; B25B 21/00; B25B 23/00; B25B 23/147; B25F 5/02

(52) U.S. Cl. CPC B25F 5/001; B25B 21/00; B25B 23/0078; B25B 23/147; B25F 5/02

(57) ABSTRACT

A geared torque tool and a unitary subassembly for the same is disclosed. The unitary subassembly comprises a motor and a geartrain. The geartrain is coupled to a rotor of the motor for torque transmission. At the same time, the geartrain is integrally coupled to the stator such that the subassembly is securably housable at least partially within an exterior housing assembly to form the geared torque tool. A method of manufacturing the geared torque tool is disclosed.

### TECHNICAL FIELD

The disclosure relates generally to portable power tools, and more particularly to subassemblies for a geared torque tool.

### BACKGROUND

Geared torque tools are portable power tools that comprise a transmission, e.g. defining a planetary gearset, and a motor providing torque to the transmission. The motor typically provides low torque at high rotational rates to the transmission, which then drives an output shaft at a relatively reduced rotational rate and high torque. For example, the output shaft may define or be coupled to a head that mates the output shaft to a threaded fastener so as to torque the fastener for fastening to a substrate. The motor is typically an electric motor powered by a battery. A controller is connected to the motor to control the motor to provide well-controlled or precision torque through the output shaft. For example, electrical current received by the motor may be monitored by the controller to infer a torque at the output shaft. The power supplied to the motor may be varied based on the torque supplied to the output shaft to achieve a precise desired torque at the output shaft.

Electric motors and transmissions in geared torque tools are commonly housed and affixed or frictionally coupled to a housing assembly. For example, frictionally coupling may involve forming an interference fit between a part of the housing assembly and complementary portion of the electric motor. The housing assembly defines an outer part of the tool (an outer shell) and will usually form a handle for use by an operator. The housing assembly is typically constructed of plastic due to manufacturability, e.g. via injection moulding, and cost effectiveness. In some cases, one or more metal elements (couplers) may connect a plastic outer shell to the motor and/or transmission.

For example, U.S. Pat. No. 10,357,871 B2 dated 23 Jul. 2019 discloses a precision torque screwdriver that has a main housing defining the outside of the tool. The main housing houses a transmission and a motor. The transmission receives torque from a motor. The transmission is affixed to the main housing. A trigger of the torque screwdriver is fixed to the main housing via a holder thereof.

A variety of off-the-shelf electrical motors and transmissions are available and may be used together in such constructions. Using well-tested off-the-shelf components can provide cost advantages and lead to improved reliability and robustness of the overall system.

Improvements in efficiency and accuracy of applied torque are desired. It desired to achieve such improvements by maintaining reliability and avoiding costly configurations.

### SUMMARY

In an aspect, the disclosure describes a geared torque tool. The geared torque tool also includes a motor defining a rotor and a stator; an exterior housing assembly securably for housing the motor by coupling to the stator; and a geartrain coupled to the rotor for torque transmission, and integrally coupled to the stator, separately from the exterior housing assembly, to support the geartrain during the torque transmission.

In an aspect, the disclosure describes a unitary subassembly for a geared torque tool. The subassembly also includes a motor defining a stator and a rotor for rotation around an axis of rotation; and a geartrain coupled to the rotor for torque transmission and directly integrally coupled to the stator axially adjacent to the motor for support and to form the unitary subassembly.

In an aspect, the disclosure describes a method of manufacturing a geared torque tool. The method of manufacturing also includes forming a subassembly by coupling a geartrain to a rotor and a stator of a motor such that torque is transmitted from the rotor to the geartrain while the geartrain is supported by the stator; and securably housing the subassembly at least partially within an exterior housing assembly.

Embodiments can include combinations of the above features.

Further details of these and other aspects of the subject matter of this application will be apparent from the detailed description included below and the drawings.

### DESCRIPTION OF THE DRAWINGS

Reference is now made to the accompanying drawings, in which:

FIG. 1A is a perspective view of an exemplary geared torque tool;

FIG. 1B is an exploded perspective view of the geared torque tool of FIG. 1A;

FIG. 2 is a side elevation view of the torque tool with a portion of the exterior housing assembly removed to expose the motor as coupled to another portion of the exterior housing assembly, in accordance with an embodiment;

FIG. 3 is a perspective partially exploded view of the torque tool illustrating construction of the exterior housing assembly to house the motor, in accordance with an embodiment;

FIG. 4 is an exploded view of the unitary drive assembly, in accordance with an embodiment;

FIG. 5A is a side elevation view of an exemplary unitary drive assembly, in accordance with an embodiment;

FIG. 5B is cross-sectional view along line 5B-5B in FIG. 5A;

FIG. 6A is an exploded perspective of a stator and a stator head, in accordance with an embodiment;

FIG. 6B is a front elevation view of the stator of FIG. 6A;

FIG. 6C is a cross-sectional view of the stator along lines 6C-6C in FIG. 6B;

FIG. 7 is a rear perspective view of the gearbox and the stator head, in accordance with an embodiment;

FIG. 8A is an exploded view of the gearbox, in accordance with an embodiment;

FIG. 8B is an enlarged view of the region 8B in FIG. 8A along with the stator head, in accordance with an embodiment;

FIG. 9 is a flowchart of an exemplary method of manufacturing a geared torque tool; and

FIG. 10 illustrates a block diagram of a computing device, in accordance with an embodiment.

### DETAILED DESCRIPTION

The following disclosure relates to geared torque tools and methods of manufacturing the same. In some embodiments, aspects disclosed herein can facilitate more accurate and efficient application of torque.

Torque generated by geared torque tools can be very large. It is desirable to have such torque generated and applied in a predictable and efficient manner. A desired torque may be applied using feedback control of the torque tool motor based on data from sensors. It is found that undesirable variations and disturbances, as well as inefficiencies, during operation of a geared torque tool can arise due to structural aspects of the geared torque tool. For example, it is found that undesirable deformation of the handle(s) and the exterior housing assembly of the torque tool during operation can lead to significant disturbances and inefficiencies if the motor and geartrain are coupled to each other via the handle(s) and/or the exterior housing assembly. A unitary subassembly (a unitary drive assembly), comprising both the motor and geartrains coupled to each other as a single unit, separate from the exterior housing assembly but coupled thereto is found to cost effectively improve structural rigidity and integrity so as to reduce undesirable disturbances and inefficiencies during operation.

In various embodiments, a stator of the motor is integrally coupled to a gear of the geartrain that is suitable to remain stationary during operation of the geared torque tool. The stator of the motor may be integrally coupled to the geartrain at least partially parallel to an axis of rotation of a rotor of the stator. In some embodiments, the geartrain and the stator may be coupled to each other via one or more intervening components lying between the geartrain and the stator.

Aspects of various embodiments are described in relation to the figures.

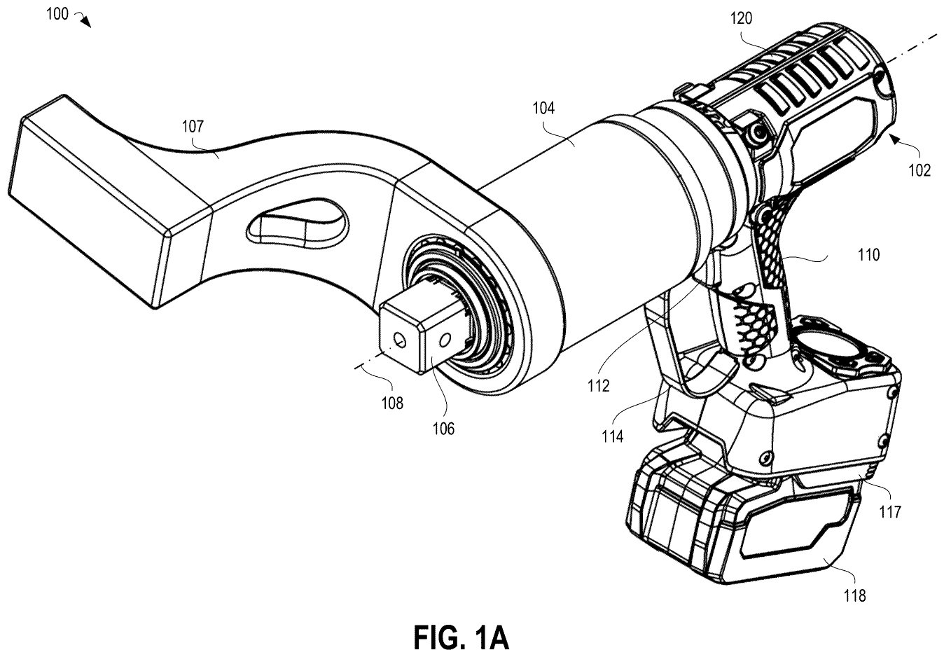

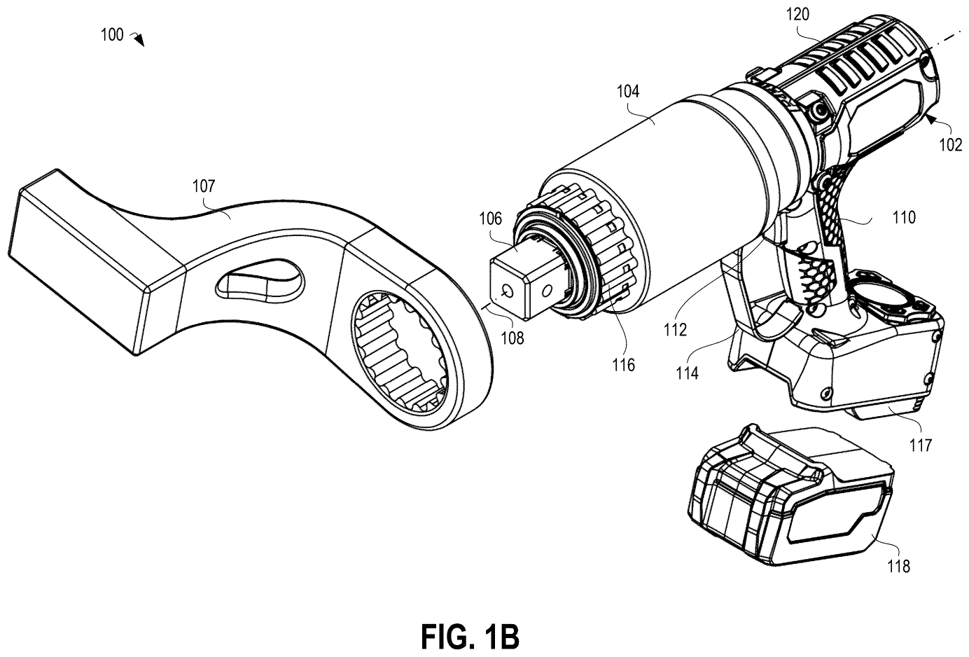

FIG. 1A is a perspective view of an exemplary geared torque tool 100.

FIG. 1B is an exploded perspective view of the geared torque tool 100 of FIG. 1A.

The torque tool 100 comprises a motor 103 securably housed within an exterior housing assembly 102. The motor 103 defines a rotor and stator. In FIGS. 1A-1B, the exterior housing assembly 102 is a handle assembly. However, it is understood that such an exterior housing assembly 102 may be free of handle(s). For example, the torque tool 100 may be remotely controlled with a pendant. In some embodiments, the exterior housing assembly 102 may be a housing of unitary construction.

For example, the motor 103 may be a brushless direct current (DC) electrical motor that may be powered via one or more batteries. It is understood that other types of motors may be suitable in certain applications.

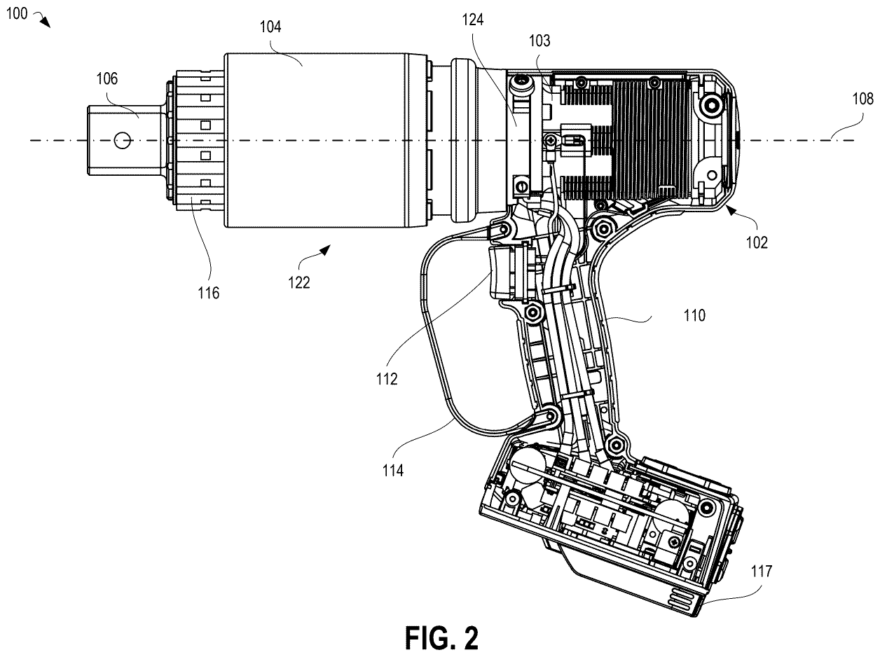

FIG. 2 is a side elevation view of the torque tool 100 with a portion of the exterior housing assembly 102 removed to expose the motor 103 as coupled to another portion of the exterior housing assembly 102, in accordance with an embodiment.

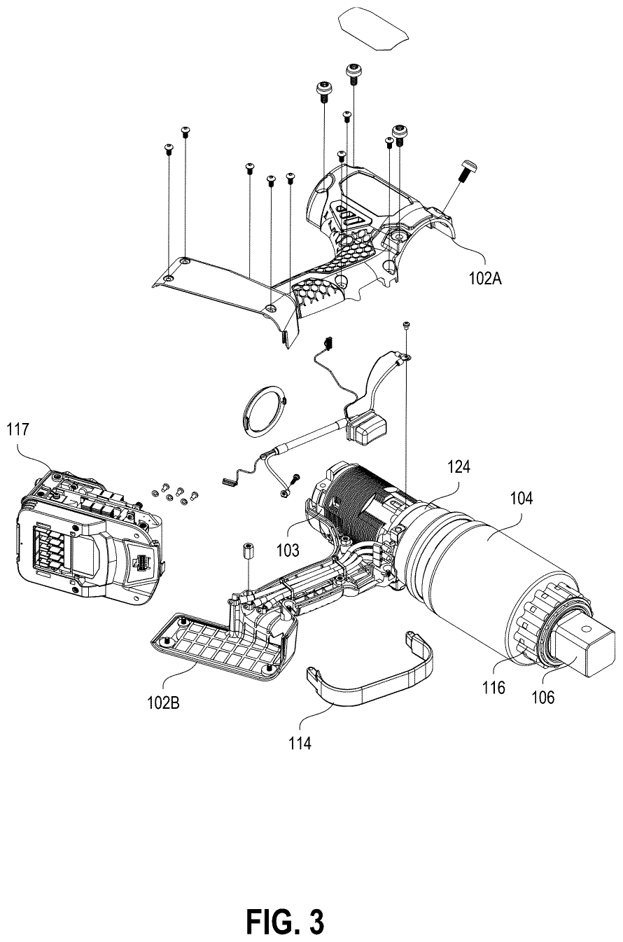

FIG. 3 is a perspective partially exploded view of the torque tool 100 illustrating construction of the exterior housing assembly 102 to house the motor 103, in accordance with an embodiment.

A stator of the motor 103 is coupled to the exterior housing assembly 102 to hold the exterior housing assembly in a stationary position relative to the rotor during operation. For example, as shown in FIGS. 1A-1B and FIGS. 2-3, the exterior housing assembly 102 may be secured to the motor 103 via a plurality of threaded fasteners.

As shown in FIGS. 1A-1B and FIGS. 2-3, the motor 103 is coupled to a geartrain of a gearbox 104 to form a unitary drive assembly 122 terminating in an output shaft 106. The unitary drive assembly 122 forms a subassembly of the torque tool 100 that acts as a single unit. As referred to herein, a “unitary assembly” may refer to components that are coupled to each other to achieve a common purpose and that are substantially rigidly attached to each other so as to form a single unit. For example, “unitary drive assembly” may refer to a motor and a geartrain coupled to each other to achieve torque transmission and attached to each other such that the stator of the motor and carriers of the geartrain are held substantially rigidly stationary relative to each other. In particular, in the unitary drive assembly 122, the geartrain is coupled to a rotor of the motor 103 for torque transmission and integrally coupled to the stator of the motor 103 via a stator head 124 to support the geartrain during such torque transmission. The stator head 124 defines a central aperture for receiving a rotor shaft. The rotor shaft extends through the stator head 124. The geartrain is directly coupled to the stator, separately from the exterior housing assembly 102, so as to form the unitary drive assembly 122 and for supporting the geartrain (by the stator) during torque transmission.

In some embodiments, the stator head 124 is fastened directly on to the exterior housing assembly 102. In FIG. 2, the stator head 124 is shown with two apertures with one of the apertures being engaged with a fastener. During construction, a portion of the exterior housing assembly 102 is integrally coupled to the stator 136 via fasteners engaging with the apertures.

In some embodiments, the motor 103 and the gearbox 104 are arranged in sequence, axially adjacent to each other (relative to a longitudinal axis 108 defining an axis of rotation of the rotor), and/or non-overlapping with (or at least partially nested within) each other. Advantageously, such a sequential arrangement may facilitate modular construction of the unitary drive assembly 122 of the torque tool 100.

The output shaft 106 extends axially outwardly from the gearbox 104 distal from the motor 103. The output shaft 106 is operable by the motor via the gearbox 104 so as to cause the output shaft 106 to rotate about the longitudinal axis 108. The output shaft 106 may define, or be suitable to couple with a tool head defining, a mating adapter or spindle for mating with a workpiece, e.g. a threaded fastener, to allow rotation thereof by the torque tool 100.

As shown in FIG. 3, the exterior housing assembly 102 comprises a first portion 102A and a second portion 102B complementary to the first portion 102A. The first and second portions 102A,102B are securably fastened to respective first and second sides of the motor 103 (sides of the stator thereof) that are opposite to each other. In such a manner, the exterior housing assembly 102 at least partially covers the motor, and a stator thereof, and forms a handle 110 of the exterior housing assembly 102 to allow an operator to grasp the torque tool 100. In various embodiments, the first and second portions 102A, 102B may be handle portions.

In some embodiments, the first exterior housing portion may be securably fastened to a first side of the gearbox 104, including its geartrain, and the second portion may be securably fastened to a second side of the gearbox 104, including its geartrain, that is opposite to the first side so as to cover the gearbox 104. The first and/or second portions may be directly fastened to the first and second sides of the gearbox 104.

In various embodiments, a trigger 112 may be mounted on the handle 110 or proximal thereto so as to allow the operator to operate the torque tool 100. In various embodiments, the exterior housing assembly 102 may further comprise a trigger guard 114 for preventing accidental engagement of the trigger 112.

A controller 117 may be housed at least partially within or between the two portions 102A, 102B of the exterior housing assembly 102. In various embodiments, the controller 117 may be housed at an end of the handle 110 distal from the motor 103. The controller 117 may be securably sandwiched between the first and second portions 102A, 102B of the exterior housing assembly 102. The controller 117 may be disposed in a pocket formed between the first and second portions 102A, 102B. In various embodiments, the controller 117 may be fastened to the portions 102A, 102B and thereby held securely between the two portions 102A, 102B. Advantageously, in some embodiments, a portion of the controller 117 (e.g. a housing thereof) may form a lower terminal end of the exterior housing assembly 102.

A battery pack 118 may be engaged with the exterior housing assembly 102. In various embodiments, the battery pack 118 may directly engage with the controller 117 and may be wholly disposed adjacent thereto. One or more batteries of the battery pack 118 may be connected to the motor 103 for powering the motor 103. For example, a dual battery pack may include two batteries acting cooperatively to power the motor 103.

In various embodiments, the exterior housing assembly 102 may at least partially be formed of plastic or other cost effective material, e.g. the portions 102A, 102B may be injection molded plastic parts. Such materials may easily deform and fail under repeated and/or excessive loading, but may provide cost advantages and improved manufacturability. For example, in some embodiments, ergonomic or textured handling surfaces may be cost-effectively achieved.

The motor may provide a high rotational speed, low torque input to the gearbox 104. In turn, the gearbox 104 may generate low rotational speed, high torque output via the output shaft 106. Advantageously, this may allow application of high torque by the use of relatively small motors.

The motor 103 may be fastened to the gearbox 104 at a low torque end of a geartrain of the gearbox 104. Advantageously, this may enhance structural integrity of the unitary drive assembly 122 as a unit, e.g. by mitigating application of high torque on to fastening or joining portions between the motor 103 and the gearbox 104.

The torque tool 100 may comprise a controller operably coupled to the motor. The torque tool 100 may comprise one or more sensors, e.g. an encoder for measuring a shaft rotation. The controller may be configured to control the motor based on data generated by the sensors so as to achieve controlled torque at the output shaft 106. Controlled torque may include a predetermined torque level or a predetermined torque curve.

The unitary drive assembly 122 of the torque tool 100 may adapted to rigidly couple to an end of an external reaction arm 107, e.g. by frictional engagement or fastening engagement of a ring 116 of the gearbox 104 with a slot on the reaction arm 107 that is complementary to the ring 116. For example, the reaction arm 107 may be a metal bar or other rigid component. Another end of the reaction arm 107 may be rigidly coupled to or attached to a non-moving structure to allow rotation of the output shaft 106, a gearset of the gearbox 104 that is engaged for rotation with the output shaft 106, and a rotor of the motor that is operably engaged with the gearset to power the shaft 106, without rotation of a stator of the motor 103, the exterior housing assembly 102, and a carrier of the gearset in the gearbox 104. Such an arrangement may be structurally advantageous, since the unitary drive assembly 122 may be held in place without putting the typically structurally weak exterior housing assembly 102 under excessive loading. It is understood that a reaction arm 107 may not be provided in some embodiments.

In various embodiments, the exterior housing assembly 102 may comprise openings 120, e.g. vents, that expose a portion of the motor to ambient air so as to allow cooling of the motor during operation. Advantageously, such portion of the motor may be a stationary (relative to the exterior housing assembly 102) portion and may comprise fins or other features to enhance heat rejection away from the motor. For example, enhanced heat rejection of a stator portion may be achieved. The exterior housing assembly 102 may additionally comprise textured surfaces for facilitating handling by an operator. For example, textured surfaces may be provided at a rear and/or side portion of the handle 110.

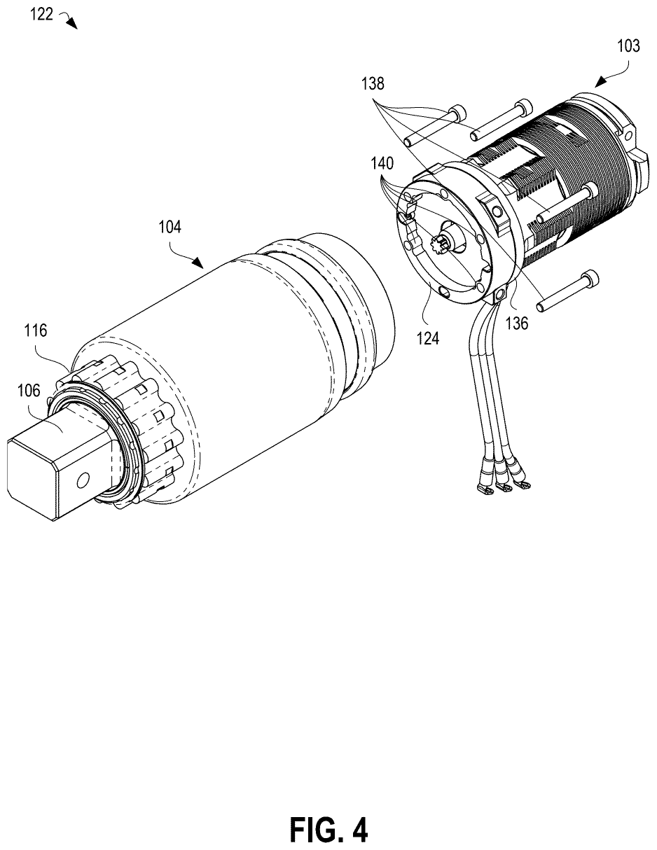

FIG. 4 is an exploded view of the unitary drive assembly 122, in accordance with an embodiment.

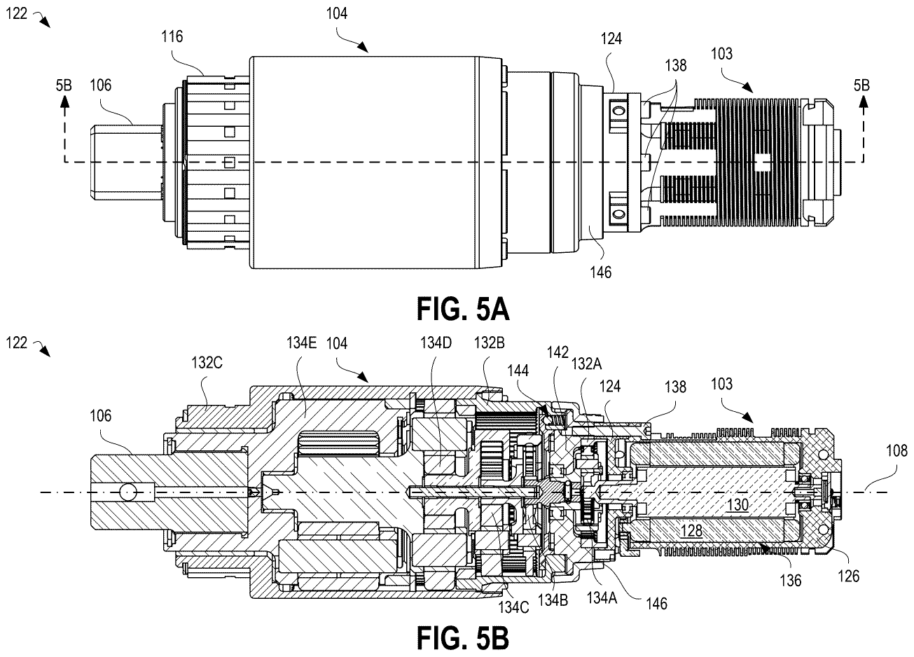

FIG. 5A is a side elevation view of an exemplary unitary drive assembly 122, in accordance with an embodiment.

FIG. 5B is cross-sectional view along line 5B-5B in FIG. 5A.

The unitary drive assembly 122 may be suitable to couple with the exterior housing assembly 102 as a subassembly of the torque tool 100. The unitary drive assembly 122 may be secured to the exterior housing assembly 102. The unitary drive assembly 122 may be partially or wholly housed in the exterior housing assembly 102. The unitary drive assembly 122 may integrally couple to a reaction arm 107 so as to hold the unitary drive assembly 122 stationary. As such, positioning and support of the motor 103 and gearbox 104 of the torque tool 100 during operation may be achieved without the exterior housing assembly 102. Advantageously, in various embodiments, ease of operation and improved rigidity may be achieved in a cost effective manner.

As shown in FIG. 4 and FIGS. 5A-5B, a rotor 130 of the motor 103 is coupled to the geartrain of the gearbox 104 for torque transmission. The geartrain is defined by a plurality of sequentially-arranged planetary gearsets 134A, 134B, 134C, 134D, 134E supported in a plurality of carriers 132A, 132B, 132C and connecting components, such as adapter plate 142. In various embodiments, the adapter plate 142 may be annulus. Each of the carriers 132A, 132B, 132C may be an annulus surrounding one or more planetary gearsets for supporting the planetary gearsets 134A, 134B, 134C, 134D, 134E for torque transmission. For example, each of the carriers 132A, 132B, 132C may define a corresponding annular or ring gear engaging with one or more planet gears of the planetary gearsets 134A, 134B, 134C, 134D, 134E.

As shown in FIG. 5B, the stator 136 may be an annular stator comprising a core 128 and a sleeve 126 attached to the core 128. Fins and other heat exchange surfaces may be formed on the sleeve 126 to facilitate heat transfer, e.g. through the openings 120. The stator 136 is integrally coupled to the gearbox 104 via the stator head 124. A plurality of fasteners 138 are sequentially received in apertures in the stator 136 and the stator head 124 to form a plurality of fastening connections. The plurality of fastening connections are distributed around a flange of the sleeve 126 to couple the geartrain to the sleeve 126.

The rotor 130 may be contained within the core 128 of the stator 136. The stator 136 may circumferentially surround the rotor 130.

As shown in FIG. 5B, a shaft of the rotor 130 engages with a sun gear of the planetary gearset 134A. The planet gears of the planetary gearset 134A are engaged with an annular gear surrounding the planet gears and defined by the carrier 132A. During operation, the planet and sun gears rotate within, and supported by, the stationary carrier 132A to transmit shaft power (torque) to the planetary gearset 134B. In an analogous manner, shaft power is transmitted from the planetary gearset 134B to the planetary gearset 134C, from the planetary gearset 134° C. to the planetary gearset 134D, and from the planetary gearset 134D to the planetary gearset 134E. During operation, the planet and sun gears of the planetary gearsets 134B, 134C rotate within, and are supported by, the stationary carrier 132B, and the planet and sun gears of the planetary gearsets 134D, 134E rotate within, and are supported by, the stationary carrier 132C. The output shaft 106 is engaged with the planetary gearset 134E to provide output shaft power.

The planetary gearsets 134A, 134B, 134C, 134D, 134E serve to increase torque from a low torque at a low torque end of the geartrain that is proximal to the motor 103 relative to the output shaft 106 to a high torque at a high torque end of the geartrain that is proximal to the output shaft 106 relative to the motor 103. The stator 136 may be integrally coupled to a low torque end of the geartrain. Advantageously, this may facilitate maintaining fastening connections between the stator 136 and the geartrain.

The carrier 132A may be engaged within the stator head 124. Keyways or slots in the carrier 132A may be engaged with protrusions 140 formed in the stator head 124 so as to integrally couple the carrier 132A to the stator 136.

During operation, the carriers 132A, 132B, 132C may be held stationary by a reaction arm 107 integrally coupled to the geartrain and to the stator 136 (via the geartrain). The reaction arm 107 reacts against a stationary structure so as to support the torque tool 100 during operation.

As shown in FIG. 5B, the planets and sun gears of each planetary gearset may be arranged in a corresponding bracket. Retaining pins and/or other fasteners may be used to couple the bracket to the planet and sun gears.

A face of the geartrain is fastened to a face of the stator 136 that is non-parallel to the longitudinal axis 108. In some embodiments, these faces may be perpendicular to the longitudinal axis 108.

The fasteners 138 may couple integrally couple the stator 136 to the geartrain via the adapter plate 142. The adapter plate 142 of the geartrain may be securably fastened to the sleeve 126 of the stator 136. The adapter plate 142 may be coupled to the carrier 132B via one or more detent assemblies, i.e. ball detent assemblies 144. In various embodiments, detent assemblies may include wave-spring assemblies. The adapter plate 142 allows coupling of the stator 136 to the annular gear (annulus) defined by the carrier 132B. In some embodiments, the stator 136 may be directly coupled to the adapter plate 142 or the annular gear defined by the carrier 132B. As referred to herein, “annulus” may refer to an annular gear.

A collar 146 surrounds the geartrain at a low torque end thereof. The collar 146 is coupled to the adapter plate 142 via slots and keys that engage with the slots.

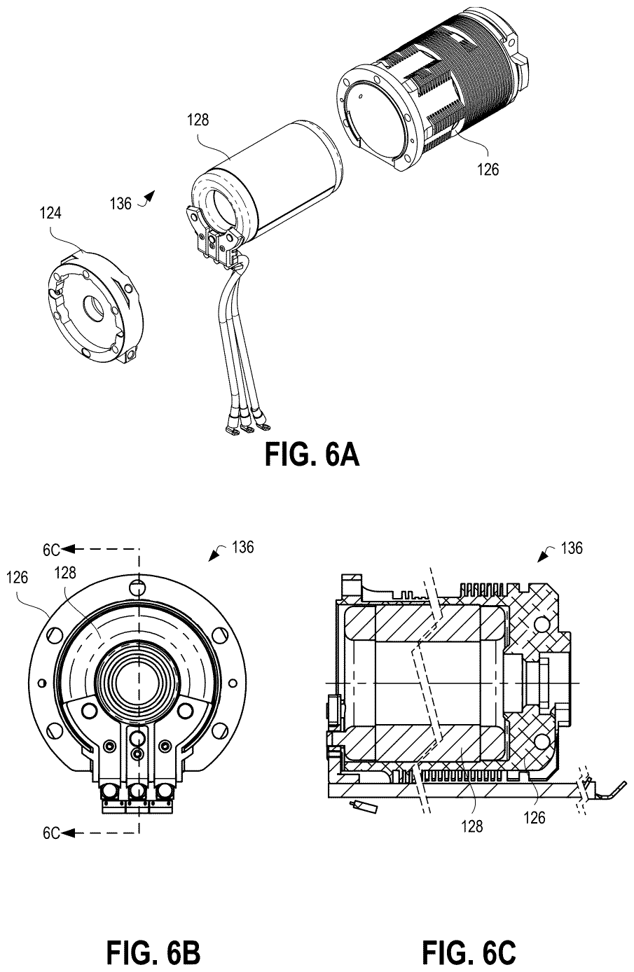

FIG. 6A is an exploded perspective of a stator 136 and a stator head 124, in accordance with an embodiment.

FIG. 6B is a front elevation view of the stator of FIG. 6A.

FIG. 6C is a cross-sectional view of the stator along lines 6C-6C in FIG. 6B.

In various embodiments, the sleeve 126 of the stator 136 is adhesively coupled to the core 128, which may be hollow to receive the rotor 130 therethrough. In various embodiments, a thermally conductive adhesive couples the sleeve 126 to the core 128 of the stator 136 to allow heat dissipation. For example, the adhesive may be a heatsink glue or other type of adhesive configured for high thermal conductivity, e.g. a thermal conductivity of 1.4 W/m·K at 25° C. In some embodiments, the adhesive may be an epoxy adhesive, e.g. a two-part adhesive. The adhesive may be configured to operate at up 150° C. or higher. The adhesive may be configured to bond metal to metal. In various embodiments, the adhesive may form a hard, durable material upon curing with a hardness of 77 D so as to rigidly couple the sleeve 126 to the core 128. Advantageously, the adhesive may be electrically insulating, e.g. a resistivity of the adhesive may be 9e12 Ω·cm or greater.

In some embodiments, the sleeve 126 is constructed of a metal or metal alloy. In some embodiments, such a metal may be Aluminum, e.g. 6061-T6 Aluminum. In various embodiments, the sleeve 126 may be constructed of copper, titanium, or magnesium, or alloys thereof.

The sleeve 126 may comprise a plurality of apertures for receiving fasteners for fastening the handling assembly 102 to the stator 136. For example, such apertures may allow fastening via threaded fasteners.

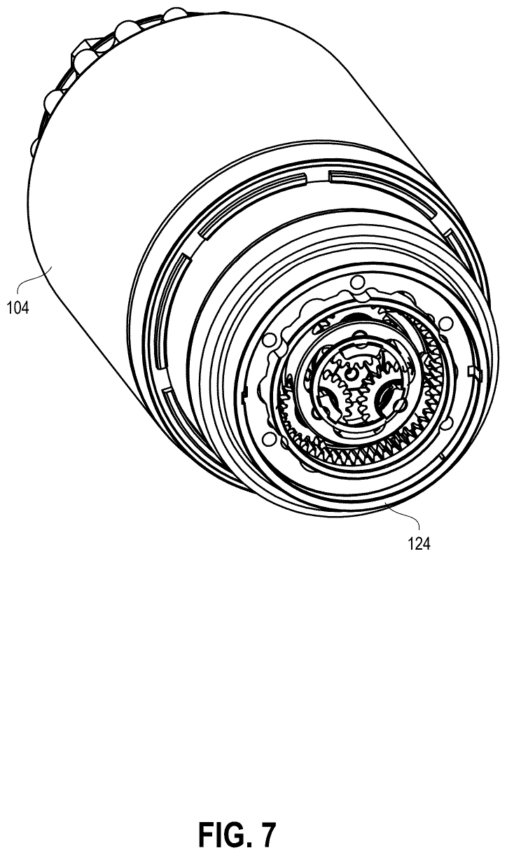

FIG. 7 is a rear perspective view of the gearbox 104 and the stator head 124, in accordance with an embodiment.

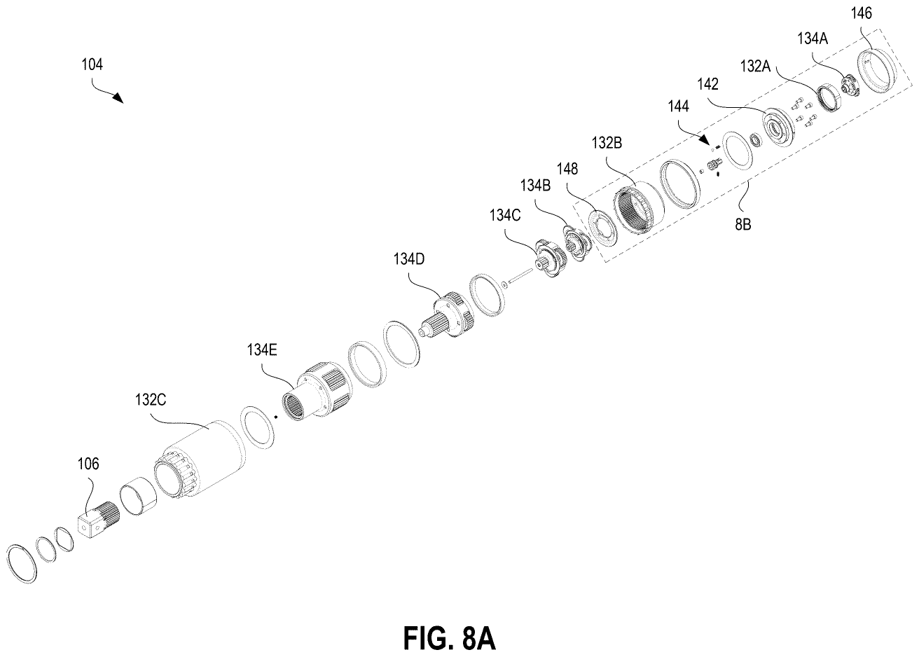

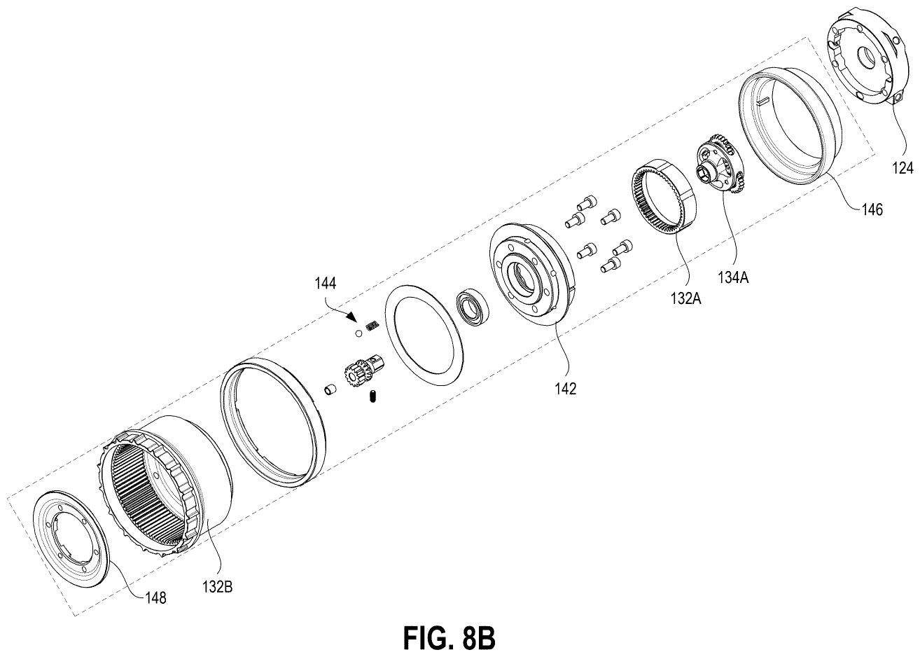

FIG. 8A is an exploded view of the gearbox 104, in accordance with an embodiment.

FIG. 8B is an enlarged view of the region 8B in FIG. 8A along with the stator head 124, in accordance with an embodiment.

The collar 146 comprises keys distributed around an internal circumference of the collar 146. The keys are protrusions that extend radially inwardly from the internal circumference. The protrusions are complementary to slots distributed around an outer circumference of the adapter plate 142 to allow engagement of the protrusions with the slots to hold the collar 146 in-place relative to the adapter plate 142. The adapter plate 142 is rigidly fastened to the stator head 124 via fasteners 138. The adapter plate 142 is also rigidly coupled to a plate 148 via a plurality of fasteners.

The carrier 132A is held stationary relative to the stator 136 by engagement of slots on an outer circumference of the carrier 132A with protrusions 140 formed in the stator head 124 to allow rotation of the planetary gearset 134A relative to the carrier 132A.

The carrier 132B is coupled to the adapter plate 142, and components attached thereto, via the ball detent assembly 144. In particular, the carrier 132B allows releasable fastening of the carrier 132B (an annular gear defined thereby) to the stator 136. As shown in FIG. 5B, the adapter plate 142 and the plate 148, once fastened to each other, define an annular space therebetween for receiving a rim of the carrier 132B. The rim of the carrier 132B includes slots or pockets for retaining therein a spring and ball of the ball detent assembly 144. A plurality of depressions, complementary to an end of the ball of the ball detent assembly 144, are formed on a rearward lip of the plate 148 that faces the rim of the carrier 132B so as to receive the end of the ball of the ball detent assembly 144 to engage therewith. The plurality of depressions may be distributed circumferentially around the lip. The plurality of depressions represent pre-set angular positions of the carrier 132B.

The carrier 132B may serve as an indexing rotor of the geartrain to allow indexing (repositioning to a pre-set angular position) of the carrier 132B relative to the stator head 124 (and adapter plate 142). Selective engagement of one or more ball detent assemblies 144, i.e. balls thereof with depressions on the rearward lip of the plate 148, allows rotation of the carrier 132B relative to the stator head 124. In particular, the ball detent assembly 144 may be selectively disengageable by torque applied to the carrier 132B (the index rotor), e.g. by causing (a non-depressed portion) to push the ball to depress the spring to release the carrier 132B for rotation relative to the plate 148 and the adapter plate 142. In this case, rotation of the carrier 132B may rotate planetary gearsets to rotate the output shaft 106. This may allow repositioning of the handle 110 by rotation of the exterior housing assembly 102 relative to the output shaft 106.

The one or more ball detent assemblies 144 may be distributed around the carrier 132B at a low torque end of the geartrain so as to ensure fastening. In various embodiments, the size and number of the ball detent assemblies 144 may be adapted to withstand applied torque and prevent slippage.

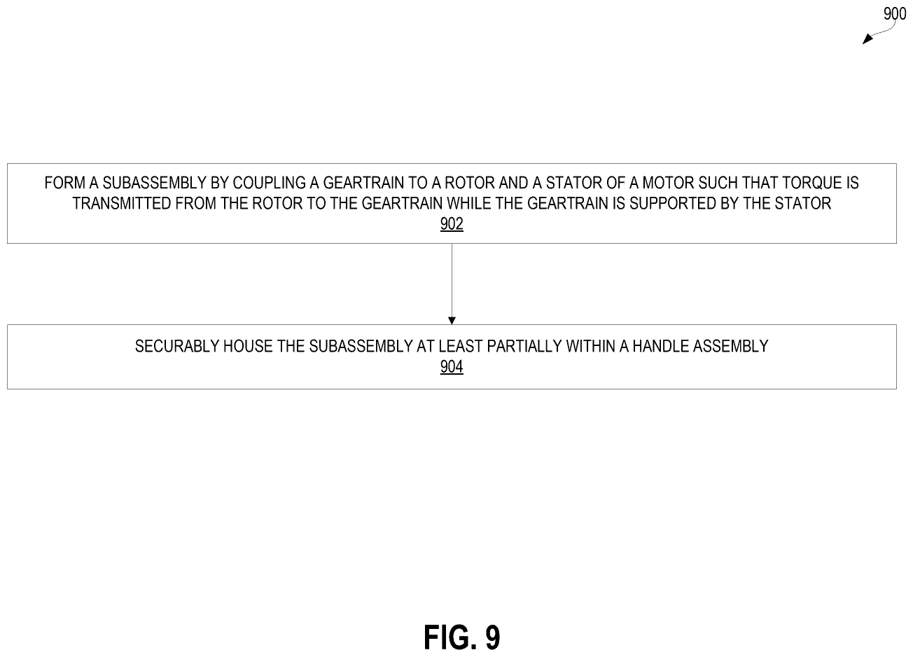

FIG. 9 is a flowchart of an exemplary method 900 of manufacturing a geared torque tool.

Step 902 of the method 900 includes forming a subassembly by coupling a geartrain to a rotor and a stator of a motor such that torque is transmitted from the rotor to the geartrain while the geartrain is supported by the stator. The geartrain may be supported rigidly by the stator.

Step 904 of the method 900 includes securably housing the subassembly at least partially within an exterior housing assembly.

Some embodiments of the method 900 include fastening the geartrain to the stator to integrally couple the stator to the geartrain.

Some embodiments of the method 900 include securably fastening a first exterior housing portion to a first side of the stator and a second exterior housing portion to a second side of the stator opposite the first side so as to at least partially cover the stator and form a handle of the exterior housing assembly.

Some embodiments of the method 900 include securably fastening the first exterior housing portion to a first side of the geartrain and the second exterior housing portion to a second side of the geartrain opposite the first side so as to at least partially cover the geartrain.

In some embodiments of the method 900, the stator is an annular stator circumferentially surrounding the rotor and integrally coupled to an annulus of the geartrain.

In some embodiments of the method 900, the annulus of the geartrain is securably fastened to a sleeve of the stator that is adhesively coupled to a core of the stator.

In some embodiments of the method 900, a thermally conductive adhesive couples the sleeve to the core of the stator to allow heat dissipation.

In some embodiments of the method 900, the annulus of the geartrain is coupled to a flange of the sleeve via a plurality of fastening connections distributed around the flange of the sleeve.

In some embodiments of the method 900, the annulus of the geartrain is an annular gear engaged with, and surrounding, a planetary gearset coupled to the rotor for torque transmission.

In some embodiments of the method 900, the geartrain comprises an indexing rotor of the geartrain that is selectively engageable to allow rotation of the exterior housing assembly relative to an output shaft of the geared torque tool.

In some embodiments of the method 900, the indexing rotor defines an annular gear releasably fastened to the stator and engaged with a planetary gearset coupled to the rotor for torque transmission.

In some embodiments of the method 900, the indexing rotor is releasably fastened to the stator via one or more ball detent assemblies distributed around the indexing rotor at a low torque end of the geartrain, the ball detent assemblies being selectively disengageable by torque applied to the index rotor.

Some embodiments of the method 900 include coupling integrally a reaction arm to the stator via the geartrain.

In some embodiments of the method 900, the stator is integrally coupled to a low torque end of the geartrain.

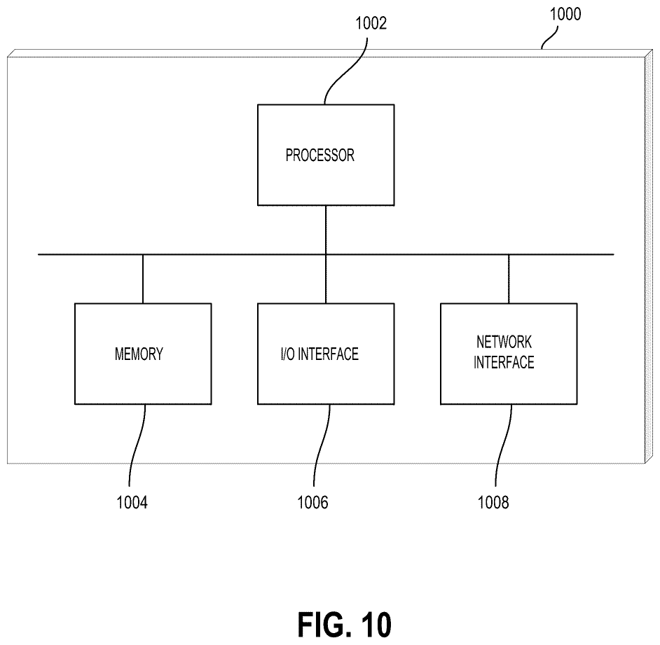

FIG. 10 illustrates a block diagram of a computing device 1000, in accordance with an embodiment.

As an example, the previously described controller to control output torque of the geared torque tool may be implemented using the example computing device 1000 of FIG. 10.

The computing device 1000 includes at least one processor 1002, memory 1004, and at least one I/O interface 1006. At least one network communication interface 1008 may be provided.

The processor 1002 may be a microprocessor or microcontroller, a digital signal processing (DSP) processor, an integrated circuit, a field programmable gate array (FPGA), a reconfigurable processor, a programmable read-only memory (PROM), or combinations thereof.

The memory 1004 may include a computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM).

The I/O interface 1006 may enable the computing device 1000 to interconnect with one or more sensors and/or input devices. A sensor may include an encoder, temperature sensor, and a current sensor. An input device may include a keyboard, mouse, camera, touch screen and a microphone, or with one or more output devices such as a display screen and a speaker.

The networking interface 1008 may be configured to receive and transmit data and/or data sets to a target data storage or data structures. The target data storage or data structure may, in some embodiments, reside on a computing device or system.

As can be understood, the examples described above and illustrated are intended to be exemplary only.

In some embodiments, the motor may comprise an annular rotor surrounding a stator located within the annular rotor. In such embodiments, carriers gears of planetary gearset may be allowed to rotate while the sun gear is kept fixed. Nevertheless, it is found advantageous for the stator to be annular and contain the rotor. For example, improved structural rigidity may be achieved.

The embodiments described in this document provide non-limiting examples of possible implementations of the present technology. Upon review of the present disclosure, a person of ordinary skill in the art will recognize that changes may be made to the embodiments described herein without departing from the scope of the present technology. For example, the motor may be a gearmotor, the indexing rotor may be replaced with a freely sliding connection of the exterior housing assembly that allows rotation of the exterior housing assembly relative to the unitary drive assembly, the ball detent assembly may be aligned normal to the longitudinal axis, and the indexing rotor may be absent with the stator being direct fastened to a carrier. Yet further modifications could be implemented by a person of ordinary skill in the art in view of the present disclosure, which modifications would be within the scope of the present technology.

1. A geared torque tool, comprising:
a motor defining a rotor and a stator;
an exterior housing assembly for securably housing the motor by coupling to the stator; and
a geartrain coupled to the rotor for torque transmission, and integrally coupled to the stator, separately from the exterior housing assembly, to support the geartrain during the torque transmission.

2. (canceled)

3. The geared torque tool of claim 1, wherein the annulus of the geartrain is securably fastened to a sleeve of the stator that is adhesively coupled to a core of the stator.

4. The geared torque tool of claim 3, wherein a thermally conductive adhesive couples the sleeve to the core of the stator to allow heat dissipation.

5. The geared torque tool of claim 3, wherein the annulus of the geartrain is coupled to a flange of the sleeve via a plurality of fastening connections distributed around the flange of the sleeve.

6. (canceled)

7. The geared torque tool of claim 1, wherein the geartrain comprises an indexing rotor of the geartrain that is selectively engageable to allow rotation of the exterior housing assembly relative to an output shaft of the geared torque tool.

8. The geared torque tool of claim 7, wherein the indexing rotor defines an annular gear releasably fastened to the stator and engaged with a planetary gearset coupled to the rotor for torque transmission.

9. The geared torque tool of claim 8, wherein the indexing rotor is releasably fastened to the stator via one or more ball detent assemblies distributed around the indexing rotor at a low torque end of the geartrain, the ball detent assemblies being selectively disengageable by torque applied to the index rotor.

10. The geared torque tool of claim 1, further comprising:
a reaction arm integrally coupled to the stator via the geartrain.

11. (canceled)

12. (canceled)

13. (canceled)

14. (canceled)

15. (canceled)

16. A unitary subassembly for a geared torque tool, comprising:
a motor defining a stator and a rotor for rotation around an axis of rotation; and
a geartrain coupled to the rotor for torque transmission and directly integrally coupled to the stator axially adjacent to the motor for support and to form the unitary subassembly.

17. (canceled)

18. The unitary subassembly of claim 16, wherein the stator is an annular stator circumferentially surrounding the rotor and integrally coupled to an annulus of the geartrain.

19. The unitary subassembly of claim 18, wherein the annulus of the geartrain is securably fastened to a sleeve of the stator that is adhesively coupled to a core of the stator.

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. A method of manufacturing a geared torque tool, comprising:
forming a subassembly by coupling a geartrain to a rotor and a stator of a motor such that torque is transmitted from the rotor to the geartrain while the geartrain is supported by the stator; and
securably housing the subassembly at least partially within an exterior housing assembly.

32. (canceled)

33. (canceled)

34. (canceled)

35. (canceled)

36. The method of claim 31, wherein the annulus of the geartrain is securably fastened to a sleeve of the stator that is adhesively coupled to a core of the stator.

37. (canceled)

38. (canceled)

39. (canceled)

40. The method of claim 31, wherein the geartrain comprises an indexing rotor of the geartrain that is selectively engageable to allow rotation of the exterior housing assembly relative to an output shaft of the geared torque tool.

41. (canceled)

42. (canceled)

43. The method of claim 31, further comprising:
coupling integrally a reaction arm to the stator via the geartrain.

44. (canceled)
